(19) United States
(12) Patent Application Publication
(10) Pub. No.: US 2026/0049510 A1
(43) Pub. Date: Feb. 19, 2026

(54) SECTIONAL DOOR WITH WALKWAY

(71) Applicant: SILVELOX GROUP S.p.A., Castelnuovo (TN) (IT)

(72) Inventor: Stefano CARLIN, Castelnuovo (TN) (IT)

(73) Assignee: SILVELOX GROUP S.p.A., Castelnuovo (TN) (IT)

(21) Appl. No.: 19/101,987

(22) PCT Filed: Aug. 2, 2023
(86) PCT No.: PCT/IB2023/057833

§ 371 Date: Feb. 7, 2025

(30) Foreign Application Priority Data
Aug. 10, 2022 (IT) 102022000017112

(51) Int. Cl. E05C 19/02; E06B 3/50

(52) U.S. Cl. CPC E05C 19/022; E06B 3/50

(57) ABSTRACT

A sectional door with walkway comprises a supporting structure; a main door comprising one plurality of panels constrained to the supporting structure in a movable manner between a closure position and an opening position; a pedestrian door, defined by one openable portion of each of the panels, the openable portion being hinged to a base portion of the respective panel; a locking device/structure/component/apparatus/unit or the like, positioned between the base portion and the openable portion of each of the panels; and an automatic movement device/structure/component/apparatus/unit or the like, operatively connected to the locking device/structure/component/apparatus/unit and configured to automatically move the locking device/structure/component/apparatus/unit in a release configuration, when the main door is in the closure position, and in a locking configuration, when the main door is not in the closure position.

### TECHNICAL FIELD

The present invention relates to a sectional door with walkway.

Preferably, the sectional door of the present invention is intended to be installed where an opening of a garage compartment is located.

It cannot, however, be ruled out that the sectional door can be installed where another type of compartment or room is located.

### BACKGROUND ART

Several types of doors are known, particularly for opening and closing a garage compartment.

A first type is overhead doors, which involve the use of a leaf that is moved with respect to a fixed frame by means of a system of pivoting arms, hinges and counterweights.

Another type is sectional doors, which comprise a leaf defined by a plurality of horizontal panels arranged in series and articulated with each other by means of hinges which allow the rotation between adjacent panels along respective axes.

These panels are mounted laterally to a supporting structure comprising a pair of vertical uprights which allow the movement of the sectional door between a closure position, wherein the panels are in a vertical position to close the opening of the compartment, and an opening position, wherein the panels are arranged horizontally to clear the opening of the compartment.

An example of such a type of doors is described in patent IT 1420181 in which, in particular, a sectional door provided with a walkway is described.

A walkway is usually understood to mean a small pedestrian door, smaller in size than the door, mainly intended to allow the passage without the need to open the door completely.

The small pedestrian door shown in patent IT 1420181 is made from reduced portions of the corresponding sectional door panels.

These reduced portions, in addition to being hinged to each other in succession and along horizontal axes, are also hinged vertically to the remaining portions of the corresponding panels to allow the small pedestrian door to be opened with respect to the door.

However, there are different types of sectional doors wherein the panels that make up the door are released from each other, that is, not hinged or connected to each other.

In this type of door, the panels are connected substantially independently to the supporting structure and perform different movements to switch between the closure position and the opening position.

These types of sectional doors do have several problems, related in particular to the fact that a possible small pedestrian door cut into the panels is not supported by the horizontal hinging of the panels, as is the case with the sectional doors shown in patent document IT 1420181.

As a result, when the panels are arranged inclined with respect to the vertical direction, that is, when the door is displaced from the closure position, the force of gravity operates on the reduced portions, thus possibly causing the small pedestrian door to open unintentionally.

### DESCRIPTION OF THE INVENTION

The main object of the present invention is, therefore, to devise a sectional door with walkway which allows avoiding any unintentional opening of the small pedestrian door.

Another object of the present invention is to devise a sectional door with walkway which can overcome the drawbacks of the prior art within the framework of a simple, rational, easy and effective to use as well as affordable solution.

The aforementioned objects are achieved by this sectional door with walkway having the characteristics of claim 1.

### BRIEF DESCRIPTION OF THE DRAWINGS

Other characteristics and advantages of the present invention will become more apparent from the description of a preferred, but not exclusive, embodiment of a sectional door with walkway, illustrated by way of an indicative, yet non-limiting example, in the accompanying tables of drawings in which:

FIG. 1 is a perspective and detailed view of the sectional door in a closure position according to the invention;

FIGS. 2 and 3 are perspective and detailed views of the sectional door at intermediate positions during the movement of the door between the closure position and opening position;

FIG. 4 is a detailed view of the locking means and of the movement means of the sectional door.

### EMBODIMENTS OF THE INVENTION

With particular reference to these figures, reference numeral 1 denotes a sectional door with walkway.

The sectional door 1 is intended to be installed where an entrance A of a room is located, such as e.g. a garage compartment, to open/close such entrance A.

For this purpose, the sectional door 1 comprises a supporting structure, not shown in the figures, which can be positioned at the entrance A of the room.

The sectional door 1 also comprises a main door 2 comprising a plurality of panels 3 constrained to the supporting structure in a movable manner, between a closure position, wherein the panels 3 are arranged one on top of the other in a substantially vertical position to close the entrance, and an opening position, wherein the panels 3 are arranged substantially horizontally to clear the entrance.

The main door 2 is, therefore, associated with the supporting structure in a movable manner between a closure position, wherein the panels 3 are lowered to close the entrance A, and an opening position, wherein the panels 3 are in a raised position and clear the entrance A.

To enable such movement, the supporting structure comprises, e.g., sliding rails attached to the walls of the room. The supporting structure of a sectional door 1 is known in the state of the art and, therefore, will not be described in detail in the remainder of this description.

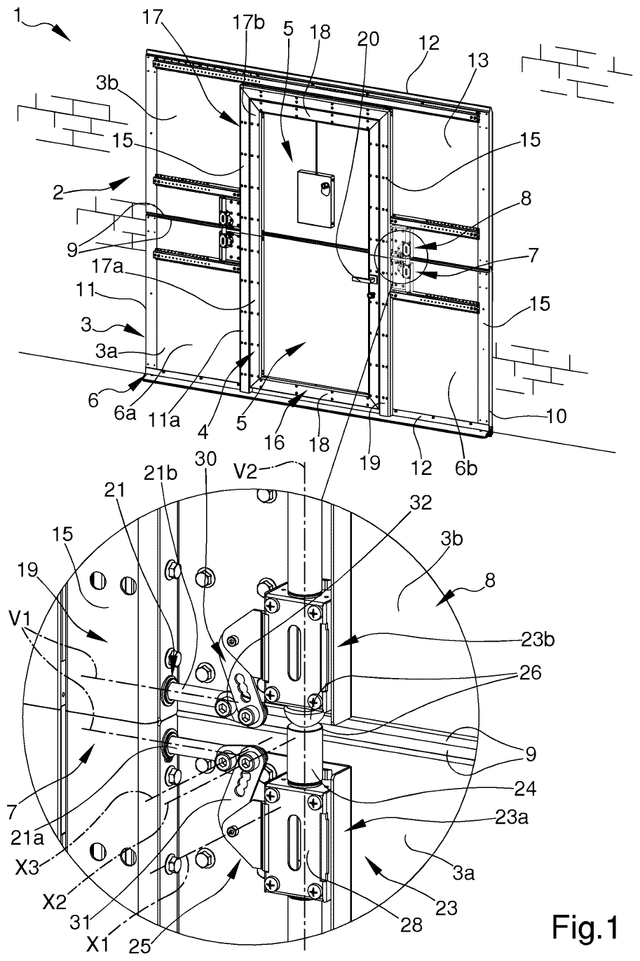

FIG. 1 shows the main door 2 in the closure position, wherein the panels 3 are arranged substantially vertically, aligned with each other and lying in the same substantially vertical plane.

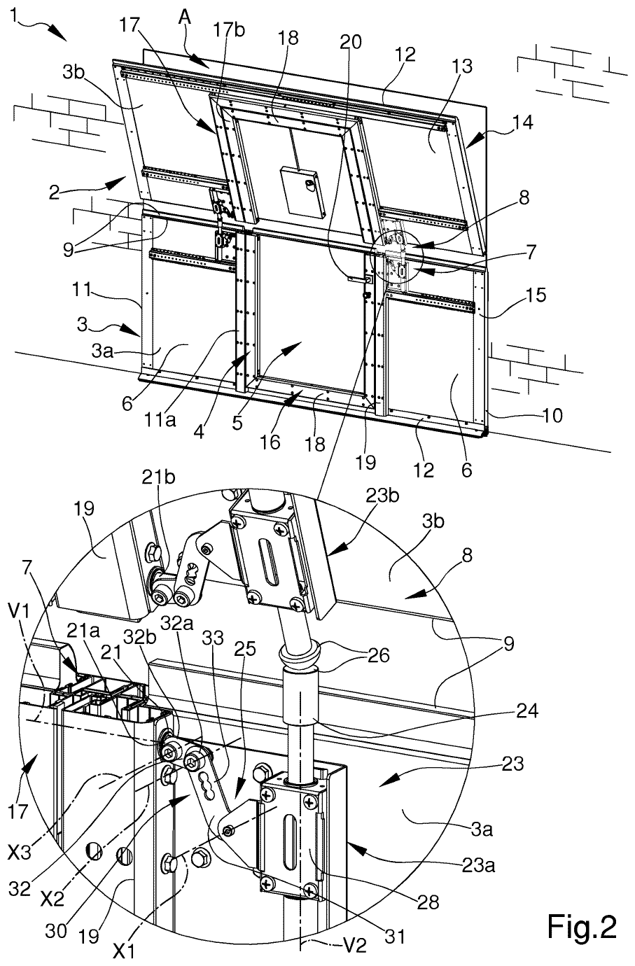

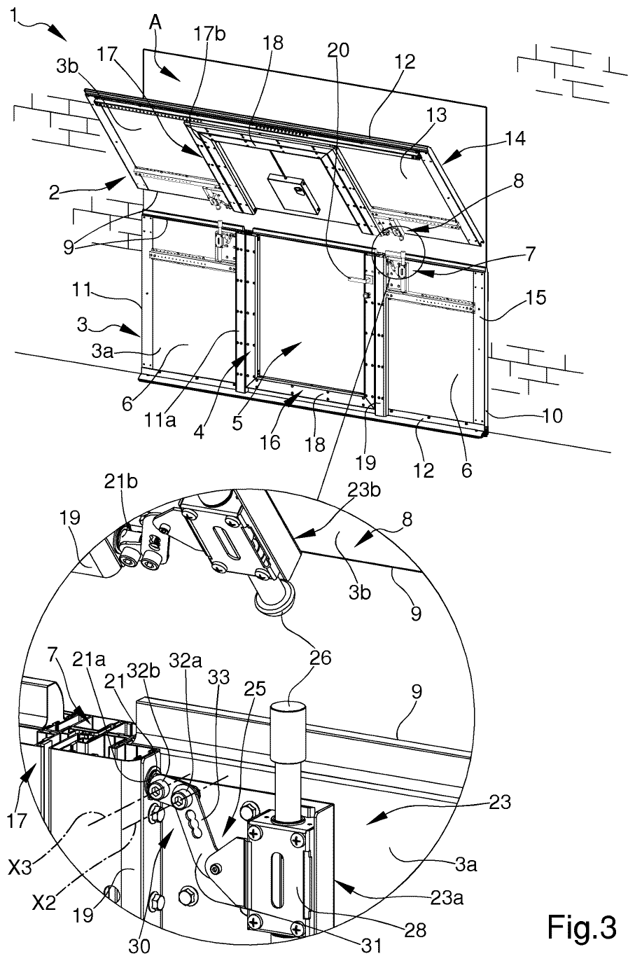

FIGS. 2 and 3, on the other hand, show the main door 2 displaced from the closure position and, therefore, at two intermediate positions that the main door 2 takes during its movement between the closure position and the opening position.

As visible from these figures, in a position other than the closure position, the panels 3 of the main door 2 are arranged inclined with respect to the vertical direction.

Additionally, the sectional door 1 comprises a pedestrian door 4 defined by at least one openable portion 5 of each of the panels 3.

The openable portion 5 is hinged to a base portion 6 of the respective panel 3 in a movable manner between an open position and a closed position.

The pedestrian door 4 is adapted to close/open an entrance defined on the main door 2. As will be described in detail later in the description, the pedestrian door 4 is made from the openable portions 5 of the panels 3 when the latter are arranged in the closure position.

Advantageously, the sectional door 1 comprises locking means 7 positioned between the base portion 6 and the openable portion 5 of each of the panels 3.

The locking means 7 are movable between a locking configuration and a release configuration.

Specifically, in the locking configuration, the locking means 7 are adapted to lock the openable portion 5 so as to prevent the movement thereof from the closed position to the open position.

In the release configuration, the locking means are adapted to unlock the openable portion 5, so that it can be moved from the closed position to the open position.

The locking means 7, in actual facts, implement a safety system that allows the pedestrian door 4 to be locked in the closed position to prevent it from being opened when the panels 3 are in an inclined position with respect to the vertical position.

In an inclined position, in fact, the openable portions 5 are subjected to the force of gravity, which tends to move them from the closed position to the open position.

Conveniently, the sectional door 1 comprises automatic movement means 8, which are operatively connected to the locking means 7 and adapted to automatically move the locking means 7 in the release configuration, when the main door 2 is in the closure position, and in the locking configuration, when the main door 2 is not in the closure position.

This expedient prevents unintentional opening of the pedestrian door 4 when the panels 3, and thus the openable portions 5, are arranged inclined with respect to the vertical direction.

The automatic movement means 8 operate automatically depending on the positioning of the panels 3, so that the pedestrian door 4 is cleared when the panels 3 are upright, i.e., in the closure position, and locked when the panels 3 are inclined with respect to the vertical direction, i.e., when they are not in the closure position.

The plurality of panels 3 comprises at least a first and a second panel 3a, 3b which, in the closure position, are arranged adjacent to each other at a respective contact edge 9.

Each panel 3 comprises at least one contact edge 9 which, in the closure position, contacts the contact edge 9 of another adjacent panel 3, closing the main door 2.

As visible from FIG. 3, the panels 3 of the main door 2 are untied from each other.

The contact edges 9 of the two panels 3a, 3b, or generally of two adjacent panels 3, move away from each other during the switch of the main door 2 from the closure position to the opening position and move close to each other during the switch of the main door 2 from the opening position to the closure position.

When the main door 2 is moved from the opening position to the closure position, the contact edges 9 are moved close to each other to contact each other and close the entrance.

When the main door 2 is moved from the closure position to the opening position, the contact edges 9 are moved away from each other, by spacing them apart from each other.

This away/close movement is shown in the sequence of FIGS. 1, 2 and 3, wherein a first part of the movement of the panels 3 from the closure position to the opening position can be seen.

In the embodiment shown in the figures, the main door 2 comprises a pair of panels 3, a first and a second panel 3a, 3b respectively.

According to one or more embodiments, the main door 2 comprises a larger number of panels 3. In such a case, first and second panels 3a, 3b preferably denote a pair of panels adjacent to each other.

Each contact edge 9 is arranged substantially horizontally.

Preferably, each panel 3 has a substantially rectangular or square shape, in which a pair of horizontal edges 9, 12 are identified opposite each other, among which at least one corresponds with the contact edge 9, and a pair of vertical edges 10, 11, opposite each other and positioned between the pair of horizontal edges 9, 12.

The vertical edges 10, 11 are arranged substantially vertically when the main door 2 is in the closure position and substantially horizontally when the main door 2 is in the opening position.

In the case of a panel 3 positioned between a pair of panels 3, both of its horizontal edges 9, 12 correspond to a contact edge 9.

In addition, each panel 3 comprises a respective inner surface 13 that, at least in the closure position, faces the inside of the room.

In addition, each panel 3 comprises an outer surface 14 which is opposite the inner surface and, at least in the closure position, faces the outside of the room.

As visible from the figures, each of the panels 3 has a substantially flat shape.

In the closure position, the panels 3 are aligned with each other with their own transverse directions arranged substantially parallel and aligned with each other, i.e., substantially vertical.

The longitudinal direction of the panels, on the other hand, is arranged substantially horizontally.

The panel 3 comprises a base portion 6 to which an openable portion 5 is hinged around an axis of rotation substantially parallel to the panel itself.

Preferably, the axis of rotation is substantially parallel to the transverse direction of the panel 3, when the main door 2 is in the closure position the axis of rotation is substantially vertical.

In the embodiment shown in the figures, the openable portion 5 is arranged substantially in the middle of the base portion 6.

Specifically, the base portion 6 comprises a first part 6a, to which the openable portion 5 is hinged, and an opposite second part 6b, with respect to which the openable portion 5 moves away/close to switch between the closed position and the open position.

Preferably, the pedestrian door 4 is openable towards the inside of the room.

Each openable portion 5 is hinged to the base portion 6 by means of hinging means, configured to allow the openable portion 5 to rotate inwards into the room during the switch from the closed position to the open position.

As visible from FIG. 1, in the closure position, the openable portion 5 is arranged aligned with the base portion 6 in the same plane.

The pedestrian door 4 comprises a perimeter frame 16 which has at least one pair of uprights 17 opposite each other.

The uprights 17 extend parallel to each other and are arranged, when the main door is in the closure position, substantially vertically.

Each upright 17 comprises a plurality of portions 17a, 17b separated from each other, each portion being arranged on one of the openable portions 5 in such a way that when the main door 2 is in the closure position the openable portions are aligned with each other.

In addition, the perimeter frame 16 comprises a pair of crossbeams 18 which extend transversely between the two uprights 17.

In particular, the crossbeams 18 are substantially parallel to each other and are arranged substantially horizontally.

In addition, the sectional door 1 comprises a counter-frame 19 associated with the base portion 6 and to which the pedestrian door 4 is connected.

The counter-frame 19 comprises a pair of uprights 15 which are arranged, when the main door is in the closure position, substantially vertically.

Each upright 15 of the counter-frame 19, similarly to the perimeter frame 16, comprises a plurality of portions separated from each other, each portion being arranged on one of the panels 3.

The perimeter frame 16 is mounted to the counter-frame 19.

In particular, at least one upright 17 of the perimeter frame 16 is mounted to one upright 15 of the counter-frame 19.

Conveniently, in addition to the locking means, the pedestrian door 4 comprises a handle and latch locking system 20 of known type.

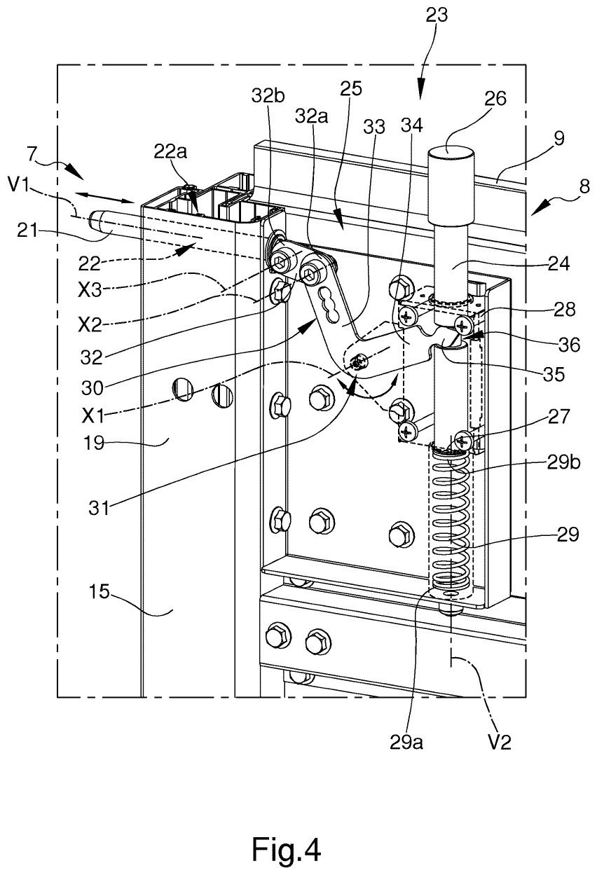

As visible in detail in FIG. 4, the locking means 7 comprise at least one locking element 21 connected to one of either the base portion 6 or the openable portion 5 of at least one of the panels 3.

The locking element 21 is movable along a direction of locking V1 between the locking configuration, wherein it is moved close to the other of either the base portion 6 or the openable portion 5 to constrain them together, and the release configuration, wherein it is moved away from the other of either the base portion 6 or the openable portion 5 to release the latter from each other.

Specifically, in the locking configuration, the locking element 21 stops against the other of either the base portion 6 or the openable portion 5 to block it.

In such a configuration, the locking element 21 is preferably fitted into a seat made on the other of either the base portion 6 or the openable portion 5.

The direction of locking V1 is substantially parallel to the transverse direction, i.e., horizontal.

Appropriately, the locking means 7 comprise at least one sliding seat 22 associated with at least one of either the base portion 6 or the openable portion 5.

The sliding seat 22 is configured to accommodate the locking element 21 in a movable manner between the locking configuration and the release configuration.

Specifically, the sliding seat 22 is configured to allow the sliding of the locking element 21 along the direction of locking V1.

Preferably, the sliding seat 22 comprises at least a first stretch 22a, associated with one of either the base portion 6 or the openable portion 5, and a second stretch associated with the other of either the base portion 6 or the openable portion 5.

The first stretch and the second stretch are positioned so that, when the openable portion 5 is in the closed position, they are arranged aligned with each other along the direction of locking V1 to allow the locking element 21 to slide.

Preferably, the sliding seat 22 is made partly on the counter-frame 19 and partly on the perimeter frame 16.

In the release configuration, the locking element 21 is not fitted in the second stretch and is retracted in the first stretch 22a. In the locking configuration, the locking element 21 is fitted in the second stretch, binding the openable portion 5 to the base portion 6.

Preferably, the locking element 21 is elongated, pin-like in shape.

In the embodiment shown in the figures, the locking element 21 is connected to the base portion 6 and is movable along the direction of locking V1 close to and away from the openable portion 5.

Appropriately, the automatic movement means 8 are configured to transform the movement of the main door 2 from the opening position to the closure position, and vice versa.

Specifically, the automatic movement means 8 transform the movement of the main door 2 from the opening position to the closure position into a movement of the locking means 7 from the locking configuration to the release configuration.

Otherwise, the automatic movement means 8 transform the movement of the main door 2 from the closure position to the opening position into a movement of the locking means 7 from the release configuration to the locking configuration.

For this purpose, the automatic movement means 8 are at least partly positioned between the first and the second panels 3a, 3b in the proximity of the contact edges 9 to transform a close and away movement of the contact edges 9 into a movement of the locking means 7 from the locking configuration to the release configuration, respectively, and vice versa.

In actual facts, the automatic movement means 8 are configured to transform the close movement of the contact edges 9 into a movement of the locking means 7 from the locking configuration to the release configuration.

Conversely, the automatic movement means 8 are configured to transform the away movement of the contact edges 9 into a movement of the locking means 7 from the release configuration to the locking configuration.

Conveniently, the automatic movement means 8 comprise at least one movement assembly 23 associated with at least one of the panels 3.

Such a movement assembly 23 is operatively connected to the locking element 21 to move it along the direction of locking V1.

As visible from FIG. 4, the movement assembly 23 comprises at least one activation element 24 connected to at least one of the panels 3 in a movable manner along a direction of activation V2.

The activation element 24 is moved along the direction of activation V2 as a result of the relevant movement of the panels 3 during the movement between the closure position and the opening position.

Appropriately, the automatic movement means 8 comprise at least one motion transmission system 25 positioned between the activation element 24 and the locking element 21.

The motion transmission system 25 is configured to transform the motion of the activation element 24 along the direction of activation V2 into a motion of the locking element 21 along the direction of locking V1.

The activation element 24, moving along the direction of activation V2, drives the motion transmission system 25, which in turn operates on the locking element 21, to move it along the direction of locking V1.

Appropriately, the direction of activation V2 is substantially parallel to the longitudinal direction of the panel 3.

The direction of activation V2 is transverse to the direction of locking V1.

When the panel 3 is arranged in the closure position, i.e. vertically, the direction of activation V2 is substantially vertical.

This arrangement of the direction of activation V2 allows the close/away movement of the panels 3 to be exploited to move the activation element 24.

As visible from the figures, the activation element 24 comprises an abutment surface 26 facing another of the panels 3.

The abutment surface 26 is adapted to abut against another abutment surface 26, arranged on the other panel 3 to move the activation element 24 along the direction of activation V2 in a first way.

In actual facts, the abutment surfaces 26 interface with each other to transform the close movement of the panels 3 into a movement of the activation element 24 along the direction of activation V2.

Preferably, such interfacing between the abutment surfaces 26 takes place by means of a direct contact between these.

It cannot, however, be ruled out that interfacing can occur through additional elements and/or forces, e.g. magnetic, operating between the abutment surfaces 26.

As visible in FIG. 4, the activation element 24 has a substantially elongated shape and extends between a pair of end portions.

Preferably, the abutment surface 26 is arranged at one of the end portions.

The automatic movement means 8 comprise a holding body 28 attached to the panel 3.

The holding body 28 defines a housing seat, adapted to house the activation element 24 in a sliding manner along the direction of activation V2.

Appropriately, the movement assembly 23 comprises an elastic element 29 positioned between the panel 3 and the activation element 24.

The elastic element 29 is configured to exert an elastic force directed, at least partly, along the direction of activation V2 in a second way opposite the first way.

Specifically, the elastic element 29 is configured to elastically deform when the activation element 24 is moved in the first way, in such a way that it loads and exerts an elastic force facing the opposite way.

By means of this expedient, when the main door 2 is moved from the opening position to the closure position, the activation element 24 is moved along the direction of activation V2 in the first way by means of the pressure exerted by the interaction between the abutment surfaces, elastically deforming the elastic element 29.

When, on the other hand, the main door 2 is moved from the closure position to the opening position, the pressure exerted on the activation element 24 by the interaction of the abutment surfaces 26 decreases, and the elastic element 29 exerts an elastic force which moves the activation element 24 in the second way.

As can be seen from FIG. 4, the elastic element is attached at one end to the panel 3, specifically to a stop surface arranged on the panel 3, and at the other end to an ending portion of the activation element 24.

This ending portion is opposite the ending portion on which the abutment surface 26 is arranged.

Preferably, the elastic element 29 is of the type of a spring.

Appropriately, the motion transmission system 25 is adapted to transform the movement of the activation element 24 in the first way into a movement of the locking element 21 from the locking configuration to the release configuration.

Conversely, the motion transmission system 25 is adapted to transform the movement of the activation element in the second way into a movement of the locking element 21 from the release configuration to the locking configuration.

This expedient makes it possible to use the elastic element 29 to keep the locking element 21 in a locking configuration when the main door 2 is not in the closure position.

Appropriately, the motion transmission system 25 comprises a knee linkage 30 provided with at least one lever 31 hinged to the panel 3 around a first axis of hinging X1.

The lever 31 is connected to the activation element 24 to be rotated by the latter around the first axis of hinging X1 during the movement thereof along the direction of activation V2.

In addition, the knee linkage 30 comprises a connecting rod 32 hinged to the lever 31 and to the locking element 21 around a second axis of hinging X2 and a third axis of hinging X3, respectively.

The direction of locking V1 is substantially parallel to the longitudinal direction of the panel 3, while the direction of activation V2 is substantially parallel to the transverse direction of the panel.

The direction of locking V1 and the direction of activation V2 are transverse to each other.

Specifically, the direction of locking V1 and the direction of activation V2 are perpendicular to each other and parallel to the panel 3.

In order to transfer the motion from the activation element 24 to the locking element 21, the axes of hinging X1, X2, X3 of the knee linkage 30 are orthogonal to the panel 3.

The activation element 24, as a result of the movement thereof along the direction of activation V2, moves the lever 31 in rotation around the first axis of hinging X1.

The connecting rod 32 transforms the rotation of the lever 31 into a linear movement of the locking element 21 to move it along the direction of locking V1.

Conveniently, the lever 31 is connected at one end to the connecting rod 32 and at the other end to the activation element 24.

At the end connected to the activation element 24, that is, at its second portion 34, the lever 31 has a connecting element 35, provided with a substantially cam-like shape which allows the linear motion of the activation element 24 to be transformed into a rotary motion of the lever 31.

In addition, the activation element 24 has a groove 36 on which the connecting element 35 is fitted.

As visible from FIG. 4, the lever 31 has a substantially “V” shape and comprises a first portion 33 and a second portion 34 which are inclined towards each other.

The portions 33, 34 join each other at a vertex, hinged to the panel 3 around the first axis of hinging X1.

The first portion 33 is hinged to the connecting rod 32, while the second portion 34 is connected to the activation element 24.

The connecting rod 32 has a substantially linear shape and comprises a pair of ends, one hinged to the lever 31 and the other hinged to the locking element 21.

As anticipated above, the pedestrian door 4 is defined by a plurality of openable portions 5.

Conveniently, the locking means 7 operate on each openable portion 5. For this purpose, the locking means 7 comprise a plurality of locking elements 21, each associated with a respective panel 3 of the plurality of panels 3.

Accordingly, the automatic movement means 8 comprise a plurality of movement assemblies 23 each associated with a respective locking element 21.

The locking means 7 comprise at least a first and a second locking element 21a, 21b associated with the first and with the second panels 3a, 3b, respectively.

The automatic movement means 8 comprise at least a first and a second movement assembly 23a, 23b associated with the first and with the second panels 3a, 3b, respectively.

The two movement assemblies 23a, 23b are connected to the respective locking elements 21a, 21b.

Conveniently, the first and the second movement assemblies 23a, 23b are configured to operate in conjunction with each other in order to transform the movement of the main door 2 from the opening position to the closure position, and vice versa, into a movement of the locking means 7 from the locking configuration to the release configuration, and vice versa.

To carry out such joint operation, the abutment surface 26 of the first movement assembly 23a and the abutment surface 26 of the second movement assembly 23b face to abut against each other during the movement of the main door 2 from the opening position to the closure position.

In actual facts, the abutment surfaces 26 of the movement assemblies 23 project from their respective contact edge 9 to face the other abutment surface 26.

When the main door 2 is moved from the opening position to the closure position, the abutment surfaces 26 interface with each other to move the respective activation element 24 along the respective direction of activation V2, thus compressing the respective elastic element 29.

Conveniently, at least one of the abutment surfaces 26 has a substantially hemispherical shape, the other of the abutment surfaces 26 has a substantially flat shape.

This expedient makes it possible to create a curved surface which facilitates the abutment between the abutment surfaces 26 during the rotation of one of the panels 3 between a horizontal position and a vertical position, and vice versa.

Preferably, the abutment surface 26 associated with the upper panel 3 is hemispherical, while the abutment surface 26 associated with the lower panel 3 is flat.

In the embodiment shown in the figures, the locking means 7 comprise a plurality of pairs of locking elements 21, each pair being associated with each panel 3.

One element of the pair of locking elements 21 is positioned between the openable portion 5 and the first part of the base portion 6, while the other element of the pair is positioned between the openable portion and the second part of the base portion 6.

Consequently, the automatic movement means 8 comprise a plurality of pairs of movement assemblies 23, each pair being associated with each panel 3.

Each group of the pair of movement assemblies 23 is operatively connected to one of the elements of the pair of locking elements 21.

Specifically, the locking means 7 comprise a pair of first locking elements 21a, associated with the first panel 3a, and a pair of second locking elements 21b associated with the second panel 3b.

Consequently, the automatic movement means 8 comprise a pair of first movement assemblies 23a, associated with the first panel 3a, and a pair of second movement assemblies 23b associated with the second panel 3b.

It has in practice been ascertained that the described invention achieves the intended objects and, in particular, the fact is emphasized that the sectional door according to the invention avoids unintentional opening of the walkway.

1) A sectional door with walkway, the sectional door comprising:
a supporting structure positionable at an entrance to a room;
a main door comprising at least one plurality of panels constrained to said supporting structure in a movable manner between:
a closure position, wherein said panels are arranged one panel on top of another panel in a substantially vertical position to close said entrance, and
an opening position, wherein said panels are arranged substantially horizontally to clear said entrance;
a pedestrian door, defined by at least one openable portion of each of said panels, said openable portion being hinged to a base portion of said respective panel in a movable manner between an open position and a closed position;
locking means, positioned between said base portion and said openable portion of each of said panels, said locking means being movable between a locking configuration and a release configuration; and
automatic movement means, operatively connected to said locking means and configured to automatically move said locking means in said release configuration, when said main door is in the closure position, and in said locking configuration, when said main door is not in the closure position.

2) The sectional door according to claim 1, wherein said plurality of panels comprises at least a first and a second panel which, in said closure position, are arranged adjacent to each other at a respective contact edge, said contact edges moving close to and away from each other during the switch of said main door from said opening position to said closure position and from said closure position to said opening position.

3) The sectional door according to claim 2, wherein said automatic movement means are at least partly positioned between said first and second panels in the proximity of said contact edges, to transform the movement of close and away movement of said contact edges into a movement of said locking means from said locking configuration to said release configuration, respectively, and from said release configuration to said locking configuration.

4) The sectional door according to claim 1, wherein said locking means comprise at least one locking element, connected to one of said base portion and said openable portion of at least one of said panels, said locking element being movable along a direction of locking between:
said locking configuration, wherein said locking element is moved close to the other of either said base portion or said openable portion to constrain said bas said openable portion, and
said release configuration, wherein said locking element is moved away from the other of either said base portion or said openable portion to release said base portion to said openable portion.

5) The sectional door according to claim 4, wherein said automatic movement means comprise at least one movement assembly associated with at least one of said panels,
said movement assembly comprising:
at least one activation element, connected to at least one of said panels in a movable manner along a direction of activation;
at least one motion transmission system, positioned between said activation element and said locking element and configured to transform the motion of said activation element along said direction of activation into a motion of said locking element along said direction of locking.

6) The sectional door according to claim 5, wherein said activation element comprises an abutment surface facing towards another of said panels and adapted to abut against another abutment surface arranged on said other panel to move said activation element along said direction of activation in a first way.

7) The sectional door according to claim 6, wherein said movement assembly comprises an elastic element positioned between said panel and said activation element, said elastic element being configured to exert an elastic force directed at least partly along said direction of activation in a second way opposite said first way.

8) The sectional door according to claim 7, wherein said motion transmission system comprises a knee linkage provided with at least:
a lever, hinged to said panel around a first axis of hinging and connected to said activation element to be rotated by the latter during the movement thereof along said direction of activation, and
a connecting rod, hinged to said lever and to said locking element around a second axis of hinging and a third axis of hinging, respectively.

9) The sectional door according to claim 8, wherein:
said locking means comprise at least a first and a second locking element, associated with said first and with said second panels, respectively; and
said automatic movement means comprise at least a first and a second movement assembly, associated with said first and with said second panels, respectively.

10) The sectional door according to claim 9, wherein said abutment surfaces of said first movement assembly face said abutment surface of said second movement assembly so that said abutment surface of said first movement assembly abut against said abutment surface of said second movement assembly during the movement of said main door from said opening position to said closure position, at least one of said abutment surfaces having a substantially hemispherical shape.
